(19) United States
(12) Patent Application Publication
(10) Pub. No.: US 2010/0153378 A1
(43) Pub. Date: Jun. 17, 2010

(54) Online Pair Wise Comparison and Recommendation System

(76) Inventor: Prashant SARDESAI, Bangalore (IN)

Correspondence Address: ALIX YALE & RISTAS LLP, 750 MAIN STREET, SUITE 1400, HARTFORD, CT, 06103, US

(21) Appl. No.: 12/636,336

(22) Filed: Dec. 11, 2009

(30) Foreign Application Priority Data
Dec. 12, 2008 (IN) 3118/CHE/2008

(51) Int. Cl. G06F 17/30

(52) U.S. Cl. 707/723; 707/812; 707/E17.014; 707/769; 707/E17.044

(57) ABSTRACT

The present invention relates to an online voting system and more particularly, the invention relates to a system having at least two key databases one being the item database in which list of movies, songs, or such/or other items of entertainment value to online users can be used and the other being the pairing database which includes a list of all paired comparisons between any two items in the said item database. Importantly the present invention is directed to a method and/or system to enable comparison of items in a database using the principals of paired comparison by applying the laws of comparative judgment.

### FIELD OF INVENTION

The disclosure relates to an online voting system and more particularly, the invention relates to a system having at least two databases one being the item database in which list of movies, songs, or such/or other items of entertainment value to online users can be used and the other being the pairing database which includes a list of all paired comparisons between any two items in the said item database. Importantly the disclosure is directed to a method and/or system to enable comparison of items in a database using the principals of paired comparison by applying the laws of comparative judgment. Thus the disclosure is capable of providing pair wise comparison to multiple users for each such paired comparison and analyzes the data that would aggregate the opinion of all users who rate these items and provide a different ranking system from commonly-used scale based ranking systems. Further the proposed disclosure allows the users to create their own pairings and all such pairings shall be available in the database for ever. Further the disclosure relates to database method and/or system that tracks votes cast by voters online wherein the results are compiled into a percentage breakup, in real-time and are represented graphically for each such paired comparison, specifically for knowledge and entertainment purposes.

The disclosure would thus provide for an online voting system that allows the users to vote for a pair of items which is cost effective and user friendly. The disclosure is thus directed to provide for recommendation system and a method of discovering good movies, songs and books based on the paired comparison. This recommendation system would not be based on correlation-based algorithms, but on aggregated human-generated ratings, unlike most other movie recommendation engines accessible online.

### BACKGROUND ART

The Internet provides a wonderful forum for mass distribution of news and other current information pertaining to movies, books and songs. Increasingly, more and more people are using the World Wide Web as their primary, or secondary, source of news and current events. One reason for the growing popularity is that the online forum offers the user an interactive experience, something that conventional television and newspapers cannot provide and provide other opportunities like online live voting polls. Online providers insert survey questions as part of their content and invite readers to respond to the survey by submitting online votes. The impromptu polls typically coincide with current topics of interest featured in the story running beside the poll. Readers respond by clicking one of the two options. This action sends a response from the user's computer to the web server at the site. The Web server adds the votes to other votes and compiles the results. The web server downloads the results to the reader during a subsequent interaction with the user's computer. The poll results are posted as part of the story for the reader to observe how other people voted in comparison to his/her own vote.

Most online rating systems relay on a scale based system (user rate each movie or book on a scale of 1-5 or 1-10). These are not reliable as they are too subjective and may not provide a user with authentic rating. These ratings systems show great variations because raters vary in their leniency. The user may rate an excellent movie 8/10 and an average movie 6/10, but a more lenient user would rate excellent movies 10/10 and average movies 8/10. Hence if the user goes to a movie's rating and see an 8/10, the user might think its excellent—since that's how the user rate movies—but it may not be so if only lenient user has voted for it. In such subjective situations, it is better to use pair wise comparisons, getting data from multiple users and analyze the data that would aggregate the opinion of all users who rate these movies or books or songs and provide a different ranking system scale based ranking systems.

One problem with live online voting is the underlying production framework for creating real-time interactive polls. Production of online voting requires a substantial amount of programming and quality-assurance testing. Typically, an editorial staff writes one or more survey questions in any manner they choose, and to derive what ever kind of response they desire. The questions may be drafted as multiple choices, open ended, essay, and so forth thereby increasing production costs.

Some attempts have been made in the past to deal with overcoming the stated limitations of the prior art such as those disclosed in the following:

U.S. Pat. No. 7,587,391 is a patent that disclosed a system and method to generate an overall ranking using the pair wise ratings. The invention is to improve search results for web pages, images, documents, etc. Moreover the system generates the pairs and the cumulative preferences over many pairs are used to generate an overall ranking and no graphical interface is used to present the results for voting between pairs. Most importantly, the result of votes on each paired comparison is not given any importance whatsoever—either for knowledge or entertainment value; the aggregated results of ALL paired comparisons are used to generate a single ranking. In addition, there is no system to track if a single user is voting multiple times on one or more of these paired comparisons.

U.S. Pat. No. 6,850,891 is a patent that disclosed a system that uses pair wise comparisons as one step in multi-layered process to help decision making in complex situations. This does not focus on each individual comparison and particularly does not focus on the entertainment domain. Moreover the system uses a 3,5,10 point scale to see user preferences between alternative.

U.S. Pat. No. 5,774,121 is a patent that disclosed a system that uses a graphical interface for decision making, using multiple criteria. Whereas the feature according to aspect of the disclosure is that uses only one criteria and an “either-or” format to decide between each alternative.

US 2009049036 disclosed an invention that is about a system that requires detailed user inputs for various items and categories of interest, and then uses detailed statistical analysis to generate recommendations. Moreover there is no use of pair wise comparisons for generating recommendations.

WO 2008128132 is a patent that disclosed a learning system based approach, where different systems are compared and then recommendations presented. This has no reference to movie, song or book recommendations and moreover not related to the use of pair wise comparisons for generating recommendations.

CA 2596443 is a patent disclosed that relates to a ranking system and not a recommendation system. It focuses on web documents rather than products or services or movies, books, songs, etc. This does not relate to use of pair wise comparisons for generating recommendations. In addition, there is no system to track if a single user is voting multiple times on one or more of these paired comparisons.

WO 2008134532 disclosed an invention that relates to a ranking system, which uses comparisons as one step in the process of ranking. Its scope is limited to online search results, and the user input is a far more complicated process than a simple EITHER-OR voting used in the disclosure. Moreover this does not provide reference to movie, song or book recommendations. There is no use of pair wise comparisons for generating recommendations.

WO 2008153625 disclosed a system that uses keyword extraction from user profiles on social networks, and uses keyword matching techniques to generate recommendations. This has limited reference to movie, song or book recommendations. There is no use of pair wise comparisons for generating recommendations.

WO 2007127296 disclosed a system that uses pair wise relations inputted by users, and does extend scope to movies, book, songs, etc. The idea is that the each individual pairing is only used as an input to the analysis system and has no entertainment/display value. Moreover the system used for analysis is a variation on a complex statistical model (MDS). It is related to a system that uses inferred relationship values, inferred from user behavior for each pair wise comparison.

It is thus clearly apparent that although a considerable number of attempts have been made in the related art to overcome the limitations of existing online voting system using pair wise comparison, it failed to provide effective solution to avoid the problems/disadvantages noted above and overcome other problems encountered in conventional methods. There has thus been a persistent need in the art to develop a system and method capable of providing an online voting system that allows the users to vote for a pair of items which is cost effective and user friendly. Further the system use pair wise comparison from multiple users and analyze the data that would aggregate the opinion of all users who rates these movies or books or songs and provide a different ranking system other than the scale based ranking system. Importantly, it provides a method and/or system to enable comparison of movies, books, songs in a database using the principals of paired comparison applying the laws of comparative judgment.

### OBJECTS OF THE INVENTION

It is thus the basic object of the disclosure to provide an online voting system having at least two databases one being the item database and the other being the pairing database.

A further object of the disclosure to provide an online voting system, wherein the item database includes a list of movies, songs, or such/or other items of entertainment value to online users.

A further object of the disclosure to provide an online voting system, wherein the pairing database include a list of all paired comparisons between any two items in the said item database.

A further object of the disclosure to provide online voting database system wherein pairs of items in a database can be compared and voted for the best by the voters online over the internet.

A further object of the disclosure is directed to a method and/or system to enable comparison of items in a database using the principals of paired comparison by applying the laws of comparative judgment.

A still further object of the disclosure is directed to a system capable of providing pair wise comparison from multiple users and analyzes the data that would aggregate the opinion of all users who rates these items and provide a different ranking system than commonly available online.

A still further object of the disclosure is directed to a system wherein the users can search for items and also search for all pairs where these items have been compared to understand how any particular item fared against other items.

A still further object of the disclosure is directed to a system and a method of providing recommendations/rankings based on the comparisons and/or votes made by the users for any particular pair of items wherein the results are tallied and the pair with the highest score would be ranked accordingly.

It is still another object of the disclosure wherein a user can only vote once for any pairing which they feel the best.

It is still yet another object of the disclosure wherein, as the votes come in, the results are compiled into a percentage breakup, in real-time and the results are represented graphically of all such compared items.

It is yet another object of the disclosure is to provide a system wherein the users are allowed to create their own pairings and all such pairings shall be available in the database for ever.

It is still another object of the disclosure is to provide a system wherein duplicate pairing is not allowed.

It is still another object of the disclosure is to provide a system wherein uses only one criteria in an “either-or” format to decide between each alternative item and further each individual pair wise rating has entertainment value on its own.

It is still another object of the disclosure is to provide a system wherein requires explicit user input for each pair wise comparison and does not uses inferred relationship values.

It is still another object of the disclosure is to provide a system wherein users are allowed to add new items (books, movies, songs or other) into the item database on their own.

### SUMMARY OF THE INVENTION

Thus according to the basic aspect of the disclosure is to provide a method for implementing a computer system having at least two databases one being the item database and the other being the pairing database for multi user online pair wise comparison and recommendation comprising:

receiving and storing items in an item database, creating unique pair of items in the item database and storing the same in the pairing database;

presenting each of the pairs of items to users for comparison between items in a pair;

providing means for the user to select and rate each item in the pair;

registering the preference of item as selected by the user in the form of votes relating to the item and displaying the same; and

compiling the results into a percentage breakup, in real-time and graphically representing the winner of all such compared items.

A still further aspect of the disclosure directed to a method for implementing a computer system having at least two databases one being the item database and the other being the pairing database for multi user online pair wise comparison and recommendation, wherein the item database includes a list of movies, songs, or such/or other items of entertainment value to online users.

A still further aspect of the disclosure directed to a method for implementing a computer system having at least two databases one being the item database and the other being the pairing database for multi user online pair wise comparison and recommendation, wherein the pairing database include a list of all paired comparisons between any two items in the said item database.

A still further aspect of the disclosure directed to a method for implementing a computer system having at least two databases one being the item database and the other being the pairing database for multi user online pair wise comparison and recommendation wherein the system is adapted to use only one criteria and registered user is allowed to vote only once in an “either-or” format to decide between each alternative items in each pairing.

A still further aspect of the disclosure directed to a method for implementing computer system having at least two databases one being the item database and the other being the pairing database for multi user online pair wise comparison and recommendation that enable the users to create unique pairing of items for comparison comprising:

choosing one item;

verifying whether the chosen item is already present in the item database, if not, allowing for the addition of a new item into the item database;

assigning the selected item as the first item in the pair of items;

choosing another item;

verifying whether the chosen item is already present in the item database, if not, allowing for the addition of a new item into the item database;

assigning the selected item as the second item in the pair of items;

creating a comparison; and

adding it to the comparison database, after adapting it to the predetermined database structure.

A still further aspect of the disclosure directed to a method for implementing computer system having at least two databases one being the item database and the other being the pairing database for multi user online pair wise comparison and recommendation that enable the users to create pairing of items for comparison wherein the system enables the user to choose the existing items for pairing ensuring that duplicate pairing of item is not allowed.

A still further aspect of the disclosure directed to a method for implementing computer system having at least two databases one being the item database and the other being the pairing database for multi user online pair wise comparison and recommendation wherein the system allows a simple process for the addition of new items into the item database.

A still further aspect of the disclosure directed to a method for implementing computer system having at least two databases one being the item database and the other being the pairing database for multi user online pair wise comparison and recommendation wherein the system enables the user to search for a particular movie, song, or such/or other item of entertainment value and use the search results to find movie recommendations based on all the existing pairings which include the searched-for movie, song, or such/or other item of entertainment value.

### BRIEF DESCRIPTION OF FIGURES

FIG. 1: is the schematic flow diagram illustrating the creating a comparison according to the disclosure. It includes the case where a new item may be added into the database if the user finds that it does not already exist

FIG. 2: is the flow diagram for functional illustration of voting on a comparison according to the disclosure.

### DETAILED DESCRIPTION OF THE INVENTION WITH REFERENCE TO THE ACCOMPANYING FIGURES

The disclosure is directed to a method of providing online voting on a system having at least two databases one being the item database in which list of movies, songs, or such/or other items of entertainment value to online users can be stored and the other being the pairing database which includes a list of all paired comparisons between any two items in the said item database based on pair wise comparison of items which is cost effective and user friendly. More preferably, the system use pair wise comparison from multiple users and analyze the data that would aggregate the opinion of all users who rates these movies or books or songs and provide a different ranking system other than the scale based ranking system.

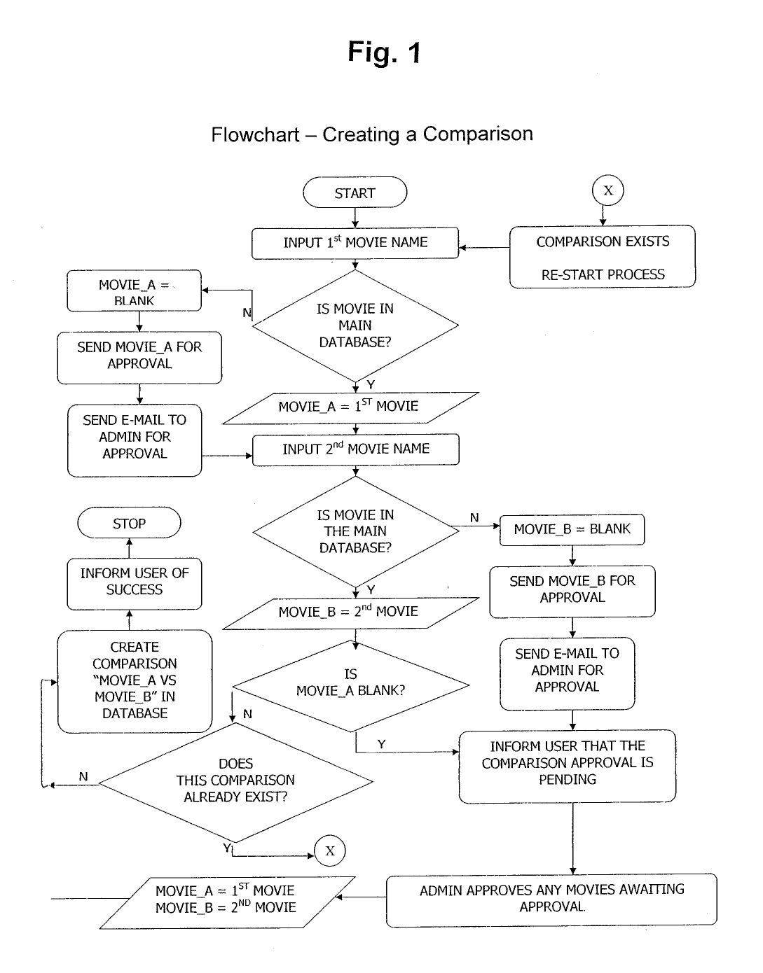

Reference is first invited to the accompanying FIG. 1, that illustrates the schematic flow diagram illustrating the creating a comparison, according to the disclosure. It is clearly apparent that the disclosure provides a method that enables the users to create pairing of items for comparison comprising: choosing one item and the system checks if the item is in the main database. If yes, then the chosen item shall be the first item in the pair of items for comparison. If no, the chosen item is sent for approval from the database to admin by an email and then added to the main database. This initiates a sub-process for addition of a new item into the database. Then the user chooses another item to be the second item in the pair of items for comparison. The system checks if the item is in the main database. If yes, then the chosen item shall be the second item in the pair of items for comparison. If no, the chosen item is sent for approval from the database to admin by an email and then added to the main database. This initiates a sub-process for addition of a new item into the database. If the first and/or second item to be compared is still blank (i.e. does not currently exist in the database) then the user is informed that the comparison approval is pending regarding addition of one/both of the items to the main database. Thus the user's first item and second item chosen are ready for comparison. If the pair of items chosen for comparison by the user already exists then the user has to restart the process. If not, comparison is created for the pair of items chosen by the user and added to the comparison database and the user is informed of the process completion.

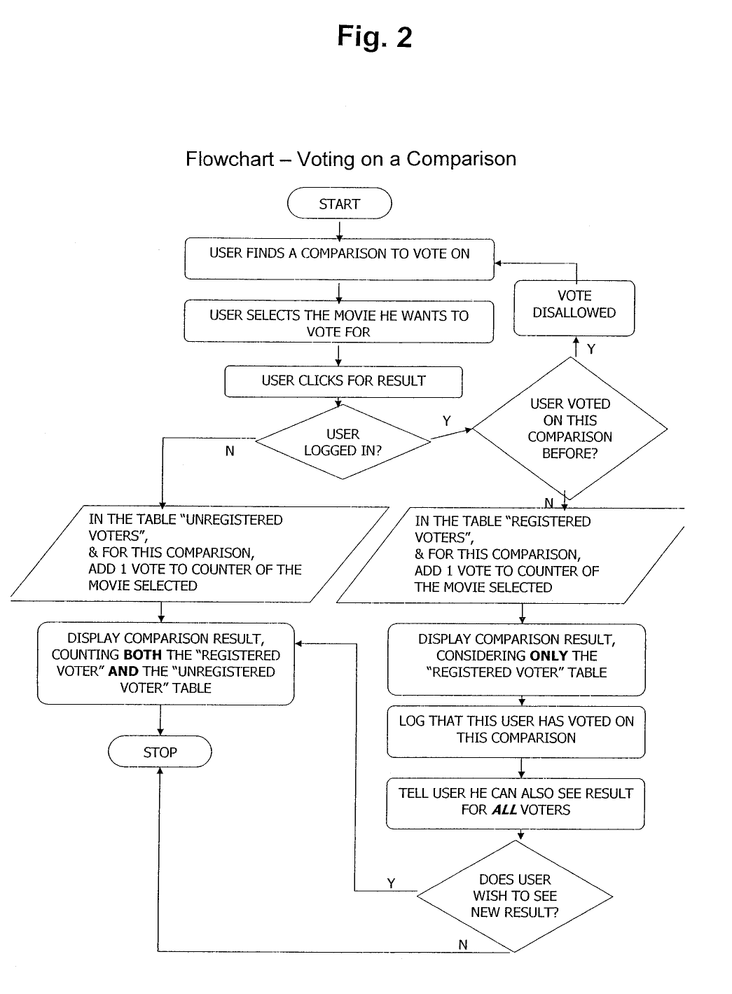

Reference is now invited to the accompanying FIG. 2 that schematically illustrates the sequence in voting on a comparison according to the disclosure. The disclosure provides a method of providing online voting on a database system based on pair wise comparison of items over the internet from multiple users comprising the steps of: receive and store pair wise items in a database; present each of the pairs of items to users for comparison between items in a pair for the selected pairs; then the user selects the preferred item to vote from the pair of items and presses the button to see the result. Further the disclosure provides a method wherein the user's login is checked. If the user is not logged in, it moves to the unregistered voters table and add one vote to counter of the item which the user had selected. If the user is logged in then it checks whether the user has voted on this comparison. If yes, the user is not allowed to vote once again. If no, it moves to the registered voters table and add one vote to counter of the item the user selected. The total votes for the selected item from the pair of items for comparison are displayed taking into account both the registered voter table and the unregistered voter table and then graphically represent the winner. Further the registered user can also see to the revised totals for all voters i.e. for registered and unregistered. If the user wishes to see the revised totals then the total votes resulted for each item from the pair of items for comparison is counted taking into account both the register voter table and unregister voter table and are displayed. Further results are compiled into a percentage breakup, in real-time and the results are represented graphically of all such compared items.

It is thus possible by way of the disclosure to develop a system and a method for providing pair wise comparison from multiple users and analyzes the data that would aggregate the opinion of all users who rates these items and provide a different ranking system other than the scale based ranking system. Importantly it is thus possible to provide a database system and/or method that tracks votes cast by voters online wherein the results are compiled into a percentage breakup, in real-time and are represented graphically. The advantages and useful application include: (i) Providing an online voting system that allows the users to vote for a pair of items which is cost effective and user friendly; (ii) A user can only vote once for any pairing which they feel the best; (iii) More specifically, system enables the users to create unique pairing of items for comparison and all such pairings shall be available in the database for ever; (iv) Uses only one criteria in an “either-or” format to decide between each alternative item and further each individual pair wise rating has entertainment value on its own; (v) Requires explicit user input for each pair wise comparison and does not uses inferred relationship values. (vi) All comparisons thus created and voted on are searchable by all users, and users may find recommended movies based on these searches for pairings and ratings. The disclosure is thus directed to provide for recommendation system and a method of discovering good items based on the paired comparison. Further results are compiled into a percentage breakup, in real-time and the results are represented graphically of all such compared items.

I claim:

1. A method for implementing a computer system having at least two databases one being the item database and the other being the pairing database the method being for multi user online pair wise comparison and recommendation comprising:
receiving and storing items in an item database, creating unique pair of items in the item database and storing the same in the pairing database;
presenting each of the pairs of items to users for comparison between items in a pair;
providing means for the user to select and rate item in the pair;
registering the preference of item as selected by the user in the form of votes relating to the item and displaying the same; and
compiling the results into a percentage breakup, in real-time and graphically representing the winner of all such compared items.

2. The method for implementing a computer system having at least two databases one being the item database and the other being the pairing database the method being for multi user online pair wise comparison and recommendation according to claim 1 wherein the item database includes a list of movies, songs, or such/or other items of entertainment value to online users.

3. The method for implementing a computer system having at least two databases one being the item database and the other being the pairing database the method being for multi user online pair wise comparison and recommendation according to claim 1 wherein the pairing database include a list of all paired comparisons between any two items in the said item database.

4. The method for implementing a computer system having at least two databases one being the item database and the other being the pairing database the method being for multi user online pair wise comparison and recommendation according to claim 1 wherein the system is adapted to use only one criteria and each user is allowed to vote only once in an “either-or” format to decide between each alternative items in each pairing.

5. A method for implementing a computer system having at least two databases one being the item database and the other being the pairing database the method being for multi user online pair wise comparison and recommendation that enables the users to create unique pairing of items for comparison comprising:
choosing one item;
verifying whether the chosen item is already present in the item database, if not allowing for the addition of a new item into the item database;
assigning the selected item as the first item in the pair of items;
choosing another item;
verifying whether the chosen item is already present in the item database, if not allowing for the addition of a new item into the item database;
assigning the selected item as the second item in the pair of items;
creating a comparison; and
adding it to the comparison database after adapting it to the predetermined database.

6. The method for implementing a computer system having at least two databases one being the item database and the other being the pairing database the method being for multi user online pair wise comparison and recommendation that enables the users to create pairing of items for comparison according to claim 5 wherein the system enables the user to choose the existing item for pairing or to restart the process if the comparison already exists in the comparison database.

7. The method for implementing a computer system having at least databases one being the item database and the other being the pairing database the method being for multi user online pair wise comparison and recommendation according to claim 5 wherein the item database includes a list of movies, songs, or such/or other items of entertainment value to online users.

8. The method for implementing a computer system having at least two databases one being the item database and the other being the pairing database the method being for multi user online pair wise comparison and recommendation according to claim 5 wherein the pairing database include a list of all paired comparisons between any two items in the said item database.

9. The method for implementing a computer system having at least two databases one being the item database and the other being the pairing database the method being for multi user online pair wise comparison and recommendation according to claim 5 wherein the system enables the user to search for a particular movie, song, or such/or other item of entertainment value and use the search results to find movie recommendations based on all the existing pairings which include the searched-for movie, song, or such/or other item of entertainment value.
